(19) United States
(12) Patent Application Publication
(10) Pub. No.: US 2018/0290504 A1
(43) Pub. Date: Oct. 11, 2018

(54) PRESSURE SAFEGUARD DEVICE FOR TIRES FILLED WITH COMPRESSED AIR, AND METHOD FOR THIS PURPOSE

(71) Applicant: GENERATION CONCEPT STIFTUNG, Schaan (LI)

(72) Inventor: Johann BERGER, Wil (CH)

(73) Assignee: Generation Concept Stiftung, Schaan (LI)

(21) Appl. No.: 15/577,994

(22) PCT Filed: Jun. 1, 2016
(86) PCT No.: PCT/EP2016/062384

§ 371 Date: Nov. 29, 2017

(30) Foreign Application Priority Data
Jun. 3, 2015 (CH) 00792/15

(51) Int. Cl. B60C 17/01; B60C 5/22; B60C 23/00

(52) U.S. Cl. CPC B60C 17/01; B60C 23/004; B60C 5/22

(57) ABSTRACT

A pressure safeguard device (1) for wheels filled with compressed gas comprises at least two tubes which are arranged next to one another in such a way as to run around the tire axis, each of said tubes having a supply line (3) for compressed gas and a common supply connection (4). On each supply line (3), a connectable and releasable connection is formed between the tube (2) and the common supply connection (4). Preferably, the tubes (2) are releasably connected, by means of a connection device (5, 6) which is separate from the tire, so as to form a stack of tubes (2) which directly adjoin one another along their circumference by way of side regions. If one tube (2) is damaged, the other tubes (2) remain intact and expand together into the entire area between the rim (7) and the tire (8). By topping up the intact tubes with compressed gas, the desired tire pressure can be achieved without changing the wheel or the tire.

The invention relates to a pressure safeguard device for wheels filled with compressed gas according to the preamble of claim 1, and to a method for ensuring predefined pressure values inside wheels according to the preamble of claim 13.

Wheels filled with compressed gas and/or compressed air are used on land and air vehicles and comprise, on a rim, at least one tire which is filled with compressed air and/or compressed gas. Both tires with tubes and tires without tubes exist. Sufficiently elastic and airtight rubber materials consisting of synthetic or natural rubber, for example butyl rubber or latex, are used for manufacturing the tubes. Butyl tubes are somewhat less heat-sensitive than natural rubber tubes, but are cheaper to manufacture. To prevent the tube inner walls and the tubes from sticking to the tire or the rim, they may be provided with talc or another adhesion-reducing agent on the inside and on the outside.

After penetration of foreign objects, such as nails, screws, stones or glass, or also in the event of damage to the tires caused by driving over obstructions, compressed air and/or compressed gas may escape, which leads to an undesired drop in pressure in the tire. If the pressure drops quickly and/or below a minimum required value while driving, there is a high risk of accidents and the tire must be changed at the location where the damage occurs. At nighttime, in extreme weather conditions and/or on remote road sections, this is not only unpleasant but can also be dangerous, especially for women. Changing a tire can also lead to important appointments being missed.

A spare wheel that may be used cannot be used long-term as a replacement for a defective tire. To reduce damage, run-flat tires with reinforced sidewalls have been developed which, in the event of damage, enable onward driving at reduced speed to a service station. For minimal damage to tubeless tires, repair sprays have been developed, the sealing medium of which is able to seal a small hole. Foaming and hardening products have the disadvantage that they bond too firmly to the rim and the tire, so that the tire and the rim may subsequently have to be replaced.

In the known solutions which enable onward driving for a short time in the event of tire damage, usually the whole tire has to be replaced, which is associated with a high cost of materials. Minor damage to a tire can be remedied using a patch and plug or a combination repair kit and a vulcanization treatment so that the tire can be reused. Because the resulting costs are relatively high in comparison to a new tire, often the whole tire is replaced even in the event of minor damage. For optimal road performance, it is even necessary also to replace the second tire on the same axle.

DE 26 31 646 describes safety tires having at least one internal dividing wall which divides the interior of the tire into at least two independent closed compartments. Either the at least one dividing wall tightly adjoins the rim, or a tube is arranged in each closed compartment of the tire. If the tire and optionally a tube is pierced at one point by a nail, only the affected compartment of the tire loses the compressed air contained therein. But at least one other compartment remains filled with compressed air and keeps the tire in a drivable condition. However, on account of the partial pressure drop, onward driving is possible only at reduced speed and only for a limited distance. Further disadvantages of this solution lie in the fact that a special rim is required for the separate valves of all the compartments and that the internal dividing walls of the tire are associated with considerable complexity during tire manufacture and with difficulties when installing the tire on the rim.

DE 199 64 211 A1 likewise describes a tire with chambers which is complex to manufacture. This tire can be installed only on special rims, which also permits the arrangement of a plurality of valves. In sectional planes including the wheel axis, the line of contact between the special rim and the tire extends substantially along a straight line. To detect and compensate for a drop in pressure, these tires include an air pressure monitoring system with tire pressure sensors which are connected via sliding contacts in the hubs to a control system of the vehicle and to a tire inflation system. Not only the shape of the tire but also the described overall system is of highly complex construction and rules out use with standard rims.

WO 2009/050740 A1 describes a tire with a plurality of separate chambers which extend in a circular fashion around the tire axis, wherein a radially inner chamber is located at the rim and further chambers are arranged between the radially inner chamber and the tread of the tire. The chamber system in the tire is very complicated to manufacture, and the whole tire has to be replaced in the event of damage.

DE 10 2010 039 854 A1 describes a wheel in which a high-pressure chamber is arranged on the rim in the interior of the tire. In the event of minimal leakage, the tire pressure can be kept constant by supplying air from the high-pressure chamber. In the event of tire damage, all the air from the high-pressure chamber also escapes in a somewhat slowed manner. The installation of the high-pressure chamber on the rim is complicated, and the tire has to be replaced in the event of tire damage. The high-pressure chamber also makes installation of the tire more difficult.

DE 43 44 524 A1 describes a wheel with a high-pressure chamber arranged in the rim and with an emergency tire which is arranged inside the tire and which can be inflated from the high-pressure chamber. In the event of tire damage, it may be the case that the element which caused the damage is still stuck in the tire. If the emergency tire on the inside of the tire is inflated, said emergency tire may also be damaged by the element causing the damage. The rim required for the described solution is of very complex construction.

The problem according to the invention is that of finding a simple solution which is compatible with conventional rims and tires and which ensures a predefined minimum pressure inside the tire in the event of tire damage leading to the escape of compressed air or compressed gas. In particular, the desired normal pressure should be able to be built up again in the whole tire even after tire damage has occurred.

The problem is solved by a pressure safeguard device having the features of claim 1 and by a method having the features of claim 13. The dependent claims describe alternative and/or advantageous variant embodiments which solve further problems.

The pressure safeguard device according to the invention for wheels filled with compressed gas, in which at least two tubes which are closed in a circular fashion are arranged next to one another in a tire in such a way as to run around the tire axis and the tire can be installed on a rim, comprises at least two, but preferably at least four, in particular at least five tubes, a common supply connection, and a supply line from each tube to the common supply connection, wherein, on each supply line, a connectable and releasable connection is formed between the tube and the common supply connection. Preferably, the tubes are releasably connected, by means of a connection device which is separate from the tire, so as to form a stack of tubes which directly adjoin one another along their circumference by way of side regions.

The solution according to the invention can be used on standard rims and in standard tires, wherein the common supply connection is arranged at the through-opening formed on the rim for a valve. The at least two circularly closed tubes used in a tire may be separated from one another. Replacement of a single defective tube is made possible by the connectable and releasable connections on the supply lines between the respective tube and the common supply connection. The undamaged tubes and the tire can continue to be used.

The preferred embodiments comprise a connection device which is separate from the tire and by means of which tubes can be releasably connected so as to form a stack. Such tube stacks with supply lines to the common supply connection on a rim can easily be inserted in a tire and installed with the tire on the rim.

In the event of tire damage, in the majority of cases only a single tube is damaged and thus the tire loses only the proportion of pressure originally provided by this tube. If at least four or at least five tubes are arranged in the tire, the running performance of the tire will be changed only a little upon losing the proportion of pressure of one tube, and the risk of an accident is very small even in the event of tire damage. The element that caused the damage remains in the area of the damaged tube or falls away from the tire. The other tubes usually remain undamaged even when the element is stuck in the tire.

In the event of tire damage involving one defective tube, the other tubes can be pumped up, optionally after removal of the element that caused the damage, until the desired tire pressure is built up again in the tire.

By virtue of the claimed method, it is possible to restore the desired tire pressure substantially at the location where the tire damage and the associated small reduction in pressure has occurred.

When using the pressure safeguard device, further advantages are obtained from the fact that the demands on the tire are reduced. Because the compressed air is accommodated in leaktight tubes, there is no need for an airtight inner layer on the tire. The stack of tubes directly adjoining one another in the direction of the tire axis along their circumference by way of side regions comprises, in the pressurized state, radially running tube walls which perform a supporting function between the rim and the tread of the tire. As a result, the demands on steel cord belt plies and/or on textile cord plies are reduced in the tire without having to accept disadvantages with regard to dimensional stability and/or rolling resistance. The bead reinforcement and/or the core profile formed on the tire for the driving stability and the steering performance can also be reduced because an adjoining tube can at least partially take over the function thereof. In order to achieve the further advantages to the greatest possible extent, in preferred embodiments the tubes are optionally provided with increased wall thickness and/or with additional plies.

According to one preferred embodiment, the pressure safeguard device comprises a tire and the circumferential lengths of the tubes are adapted to said tire in such a way that, after being arranged in the tire and inflated to a first degree of filling, they run with their smallest circumferential lines facing toward the tire axis around the tire axis at a radius which is a predefined amount larger than the inner radius of the tire edge lines with the smallest circumference of the tire. The free space provided in the tire with the tubes at the smallest circumference of the tire enables problem-free installation on the rim.

First, the tubes are connected via the supply lines to the common supply connection, which is preferably arranged at a through-opening of the rim. The tubes are then inflated via the common supply connection to a first degree of filling so that the tubes are held in the tire and provide the desired free space. In this state, the tire can be installed on the rim without any problem because the free space is large enough for the radially outwardly projecting rim edge.

Once the tire containing the tubes has been installed on the rim, the tubes can be filled with compressed gas until the desired tire pressure has been built up in the tire. Once the tire tightly adjoins the rim, the air between the tubes and the rim cannot escape. It is therefore advantageous if at least the through-opening through the rim or the inserted common supply connection also provides a vent connection from the interior space between the rim and the tire to the surrounding environment. It goes without saying that additional vent openings through the rim may also be formed, so that the tubes are inflated in such a way that substantially no residual air remains between the tubes and the rim or the tire.

In order for the tubes to bear optimally against one another and against the inner side of the tire and also the rim upon inflation, optionally at least parts of the outer surfaces of the tubes are made slideable by means of a coating or by applying a powder.

In the fully inflated state, tube walls of adjacent tubes bearing against one another extend substantially radially from the rim to the inner side of the tire facing away from the tire tread. On account of the pressure in the tubes and possibly also on account of connection means arranged on the tubes for holding the adjacent tubes together, the radially running tube walls are stiffened and could be subjected to considerable mechanical stress by the compression and decompression occurring periodically during the rolling of the wheels.

According to one preferred embodiment, annular damping elements are arranged between the tube walls bearing against one another, preferably close to the inner surface of the tire. With such a damping element, both tube walls deviate somewhat from the radial orientation. In compression phases, the radially oriented portions press against the damping element, which is able to absorb the compression. To this end, the damping element is elastic, possibly made of sponge rubber or of a sufficiently elastic or damping plastic.

In special embodiments, annular damping elements between adjacent tubes also perform a connection function in addition to the damping function. To this end, they comprise at least regions with hook-and-loop elements, form-fitting connection elements or releasable adhesive.

The tube walls of adjacent tubes, which extend radially from the rim to the inner side of the tire at the tire tread, and the tube regions located therebetween lead to slightly different pressure forces across the tire width. With exact contour specifications across the tire width, for the tube walls extending radially to the tire tread, that is to say for the contact regions between tubes, minimally smaller radial dimensions of the annular partial surfaces of the tire tread can be measured than in regions therebetween. The outer contour running in a sectional plane through the tire axis shows minimal deviations from the desired contour. The deviations lie for example only in the range from 0.02 to 0.2 mm and also depend on the tires in question, in particular on the steel cord belt plies and/or textile cord plies thereof and/or on the rubber cross-sectional profiles and/or on the rubber compound.

According to one preferred embodiment, intermediate tubes are arranged directly adjacent to the inner surface of the tire in regions where the tube walls bear against one another. In the pressurized state of the tire, these intermediate tubes have smaller cross-sectional areas than the other tubes in planes through the tire axis, and they reduce the radial extent of the radially oriented portions, bearing against one another, of the tubes arranged respectively on each side. In a direction parallel to the tire axis, these intermediate tubes lead to an equalizing of the pressure bearing against the inner side of the tire tread and thus also make the contour of the tire tread more uniform. This in turn ensures better force transmission between the tire and the road.

The effort involved in achieving a desired continuous contour of the tire tread for the tire can correspondingly be reduced. In particular, tires with simpler steel and/or textile plies and/or with a modified tread geometry can be used without adversely affecting the contour profile. In addition, in compression phases, the intermediate tubes reduce the forces acting on the tube walls extending radially relative to the tire tread.

Each intermediate tube is connected via a supply line to a common supply connection. Optionally, the supply line leads from the intermediate tube to the common supply connection and is connected thereto via a releasable connection. In one preferred embodiment, the connection of the intermediate tube to the common supply connection runs via an adjacent tube and from the adjacent tube, via the supply line thereof, to the common supply connection, wherein at least one connectable and releasable connection is formed on this connection path, preferably at the common supply connection.

In order that, in the event of a damaged intermediate tube, lots of compressed gas cannot also escape undesirably from the adjacent tube connected thereto, a differential pressure closing device is preferably inserted between said two tubes. This makes it possible to close the connection between the intermediate tube and the tube connected thereto by using the pressure of at least one intact tube.

In another preferred embodiment, the common supply connection is arranged at a through-opening of the rim. The common supply connection comprises a supply opening on the side of the rim radially close to the axle and facing away from the tire, and a closure region for each supply line on the side facing radially away from the wheel axis, wherein these closure regions, preferably in a pretensioned manner, close all the connections from the supply opening into the supply lines individually. This ensures that, in the event of one leaking tube, the other tubes do not discharge compressed gas through the defective tube to the surrounding environment via their supply lines.

According to one preferred embodiment of the common supply connection, the supply opening thereof is provided with a check valve in a manner analogous to a standard valve, which check valve can be opened by pushing in a central pin. If moving this pin also moves the closure regions away from the connections to the supply lines, compressed gas can thus be discharged from the tubes or, in the event of a higher pressure on the side of the supply opening, compressed gas can be filled into the tubes. It goes without saying that optionally only the pretensioned closure regions are provided, without an additional standard valve.

In one preferred embodiment, the spacings between the closure regions increase or decrease along the substantially radially extending longitudinal axis of the supply connection. The lines of intersection of the closure regions with normal planes to the longitudinal axis may be rectilinear or curved. Preferably, the closure regions are formed by partial surfaces of a displaceable valve body, wherein the valve body is arranged in a correspondingly formed housing with openings to the supply lines. The closing pretension between the housing and the valve body is preferably achieved by at least one spring element.

The openings and the supply lines connected thereto can be tightly connected via releasable connections. In particular, annular grooves are formed at the openings and the end regions of the supply lines comprise corresponding annular beads for engaging in the annular grooves. Because the internal cross-sectional area of the supply lines can be selected to be small, the forces to be absorbed by engagement-type connections are small.

The wall thickness and dimensional stability of the supply lines is preferably great enough that the latter remain open even when they are loaded from outside with customary tire pressures. This load capacity is necessary for emptying the tubes because the supply lines run inside the tire from the tubes to the common supply connection and thus are loaded on their outer side with the tire pressure.

In order that, when topping up compressed gas into a plurality of supply lines connected to a common supply connection, one of which supply lines leads to a defective tube, the supplied compressed gas cannot escape through the defective tube into the surrounding environment, in a further preferred embodiment a differential pressure closing device is used for each tube. This makes it possible to close the connection through the common supply connection to the defective tube by using the pressure of at least one intact tube.

In one particularly advantageous embodiment, the differential pressure closing device for each connection of a tube to the supply line thereof comprises a closing element for closing the connection from the supply line into the tube. The closing element is kept open by an opening device with a predefined opening force, wherein, in the case of at least two tubes which are arranged in a tire and are originally filled with compressed gas, after a leak has occurred in one tube the at least one remaining intact tube filled with compressed gas flattens the tube with the leak and thereby moves the closing element thereof into a closed position counter to the opening force. This prevents the situation whereby, when topping up with compressed gas through the common supply connection, an undesirably large amount of the supplied compressed gas can escape through the tube with the leak. The majority of the supplied compressed gas enters the at least one other tube.

The differential pressure closing device is optionally formed in an analogous manner in the common supply connection, wherein then for example membranes can be actuated by the effective pressures in the tubes so that the passage to a defective tube is closed by membranes pressed together counter to an opening device.

The connection device which holds the tubes together as a tube set comprises at least one connection means which is arranged on at least one tube or which at least partially surrounds the tubes.

A connection means which is arranged on at least one tube comprises connection elements which are arranged preferably on at least one side of the tube and which are arranged in the circumferential direction of the at least one tube at least at two locations distributed substantially evenly around the circumference, wherein said connection elements are preferably formed of elements for hook-and-loop connections, latching connections or form-fitting connections or optionally of regions containing an adhesive which achieves a releasable connection. In the case of advantageous hook-and-loop connections, each tube will have first hook-and-loop elements on one side in the direction of the tire axis and second hook-and-loop elements on the other side, wherein the first and the second hook-and-loop elements can be releasably connected to one another.

In one preferred embodiment, a connection means which at least partially surrounds the tubes is formed of a flat material which can be arranged around the tubes in a sleeve-like manner at least in a circumferential region of the tubes. In order that this flat material is easy to install and does not cause disruptive stress on the tubes while driving, use is preferably made of a textile flat material which can easily be brought into a closed shape around the tube stack, wherein a connection arrangement, preferably comprising a releasable hook-and-loop connection, form-fitting connection or adhesive connection, is provided at a contact region or overlap region.

If the flat material has to keep the tubes together in the form of a stack only during installation, it may be extremely minimal, for example in the form of a knitted fabric. If the flat material also forms a reinforcement between the tire and the tubes, it will in particular be designed in such a way that, in the event of a damaged tire, no tube region can escape through the damaged site.

In the method according to the invention for ensuring a predefined pressure value of a pressure safeguard device, after a pressure reduction due to a defective tube a compressed gas source, preferably a compressed gas cylinder, is connected to the common supply connection and substantially the volume of gas that escaped from the defective tube is filled into the leaktight tubes until a predefined pressure value is reached in the tire.

The method in which a compressed gas cylinder is connected to the common supply connection has the advantage that the size and filling of this cylinder can be such that substantially the volume of compressed gas that has escaped from one tube is replaced. The person doing the topping up need not know the pressure to which the tire is being filled. There is no need to actively interrupt the filling operation at the correct pressure. It is advantageous if an end indicator is provided on the compressed gas cylinder, from which it can be seen whether a sufficient pressure has built up in the tire at the end of topping up. If the end indicator indicates insufficient pressure, it must be assumed that at least one other tube is defective and topping up with another compressed gas cylinder is necessary.

If the wheels of a vehicle are equipped with pressure safeguard devices according to the invention, in the majority of cases it is sufficient to carry at least one compressed gas cylinder in order to ensure substantially unrestricted onward driving after a drop in pressure in a tire. A compressed gas cylinder allows an easy and quick top-up of the undamaged tubes without particular technical knowledge. When quickly topping up, the person doing the topping up is occupied outside the vehicle only for a very short period of time, so that the risk of trouble or exposure to weather conditions is very small. There is no need to carry a spare wheel and tools for changing a wheel. The space taken up by the small compressed gas cylinder is much smaller than the space taken up by a spare wheel and tools. In addition to gaining more space, the basic weight of the vehicle and thus the energy consumption for driving are also reduced.

To top up a defective tire, compressed gas in the form of nitrogen is preferably used. A pressure cylinder containing nitrogen is also not associated with an increased risk of fire or explosion in the event of damage caused during an accident.

The drop in pressure in a tire containing the pressure safeguard device is limited and yet easy to identify. If a tube is defective in one wheel of an axle, there is a difference in rotational speed or circumference between the two wheels of said axle, which can be identified via the ABS system or via the indirect tire pressure monitoring system. If the vehicle is driving straight ahead, a damaged tire can be identified with sufficient certainty due to the difference in the rotational speed of these two wheels. There is no need for complex direct measurements of wheel pressures and/or distances between axle regions and the ground.

The described possibility of easily detecting a drop in pressure via values of the ABS system or of the indirect tire pressure monitoring system is one advantage of the pressure safeguard device over the use of “run-flat” tires, in which, due the relatively rigid side faces, the external diameter of the tire does not decrease enough even in the event of a pressure drop, so that pressure measurements are necessary in order to detect a tire defect. Run-flat tires also require significantly larger amounts of material and a complicated structure to ensure only a limited possibility for onward driving.

According to another preferred embodiment, each tube of the pressure safeguard device is assigned its own pressure accumulator and the connections from the common supply connection to the tubes take place in a parallel manner via supply lines, the associated pressure accumulators and top-up lines connected thereto. Arranged between the pressure accumulators and the tubes are pressure-reducing valves which ensure that the supply to each tube takes place until a predefined pressure value is reached in the tire and starts again when there is a drop below the predefined pressure value in the tire.

A check valve is optionally arranged between each pressure-reducing valve and the tube connected thereto, which check valve prevents gas from flowing back out of the tube toward the pressure accumulator, wherein then, in order to vent the tubes, a vent line is connected to each tube and at least one vent valve is connected to the vent lines. The at least one vent valve comprises a closure region for each vent line, wherein these closure regions, preferably in a pretensioned manner, close all connections from the vent lines to a vent opening individually. This ensures that, in the event of one leaking tube, the other tubes cannot discharge compressed gas through the defective tube to the surrounding environment via their vent lines.

According to one preferred embodiment, the vent valve is configured in a manner analogous to a check valve, in particular to the supply connection described above with closure regions for a plurality of lines. If the movement of the closure regions is moved away from the connections to the vent lines, compressed gas can be released from the tubes or, in the event of a higher pressure on the side of the vent opening, compressed gas can be filled into the tubes.

The pressure accumulators comprise shaping means which restrict the expansion of the pressure accumulators when filling with the compressed gas or when building up an overpressure that is substantially above the predefined tire pressure. The overpressure required depends on the volume of the pressure accumulator, on the desired tire pressure, and on the top-up volume to be achieved in the associated tube, wherein the top-up volume to be achieved can be determined from the total number of tubes, the maximum number of defective tubes to be compensated, and the volume to be filled by the tubes in the tire.

If, in the case of four tubes, the intention is to be able to compensate for one defective tube, the pressure accumulators of the remaining three tubes together must be able to top up the volume that has escaped from the defective tube, that is to say ¼ of the interior space of the tire, until the desired tire pressure is reached. Accordingly, one pressure accumulator must be able to fill 1/12 of the tire interior with the desired tire pressure. If the volume of each pressure accumulator is substantially 1/12 of the tire interior, the overpressure in each pressure accumulator must be at least twice the tire pressure so that, in the event of a defective area, the tire pressure can be built up via the remaining three tubes. If the volume of the pressure accumulators is different, this results in a correspondingly different required overpressure.

The tubes must be arranged internally in the tire adjacent to the tread, and accordingly the pressure accumulators must be positioned radially inside the tubes. Besides an arrangement in the wheel interior between the rim and the tire, according to one advantageous solution the pressure accumulators are arranged on or in the rim, this embodiment being configured in such a way as not to adversely affect the installation of a tire on the rim with the pressure accumulators. If the pressure accumulators on the rim extend annularly around the wheel axis, they provide the desired compressed gas for topping up the tubes and they also increase the stability of the rim.

In one preferred solution, at least four, but preferably at least five pressure accumulators are used, wherein the pressure accumulators, preferably as elements running in a circular fashion around the tire axis or rim axis, then run radially toward the tire axis on the associated tubes and in one advantageous solution are connected to the tubes or optionally to one another via a releasable connection.

If the pressure accumulators are arranged in the interior space between the rim and the tire, the circumferential lengths of the pressure accumulators are adapted to an associated tire in such a way that, once the tubes and the pressure accumulators have been arranged in the tire and the tubes have been inflated to a first degree of filling, the smallest circumferential lines of the pressure accumulators facing toward the tire axis run around the tire axis at a radius which is a predefined amount larger than the inner radius of the tire edge lines with the smallest circumference of the tire, wherein the tire edge lines bear against the rim in the installed state. Easy installation on the rim is thus ensured.

After fully building up pressure in the tubes and building up an overpressure in the pressure accumulators, the tubes and the pressure accumulators fill the entire interior space of the tire. To this end, it may be necessary that each tube at least partially surrounds the associated, somewhat more dimensionally rigid pressure accumulator and thus fills the original free space between the rim and the pressure accumulators.

The drawings explain the invention on the basis of exemplary embodiments, but the invention is not limited thereto. In the drawings:

FIG. 1 shows a perspective view of a pressure safeguard device with four tubes, each of said tubes having a supply line for compressed gas, a common supply connection and a connection device which releasably connects the tubes to one another,

FIGS. 2 and 3 show perspective views of four tubes, each of said tubes having a supply line and connection means arranged on the tubes,

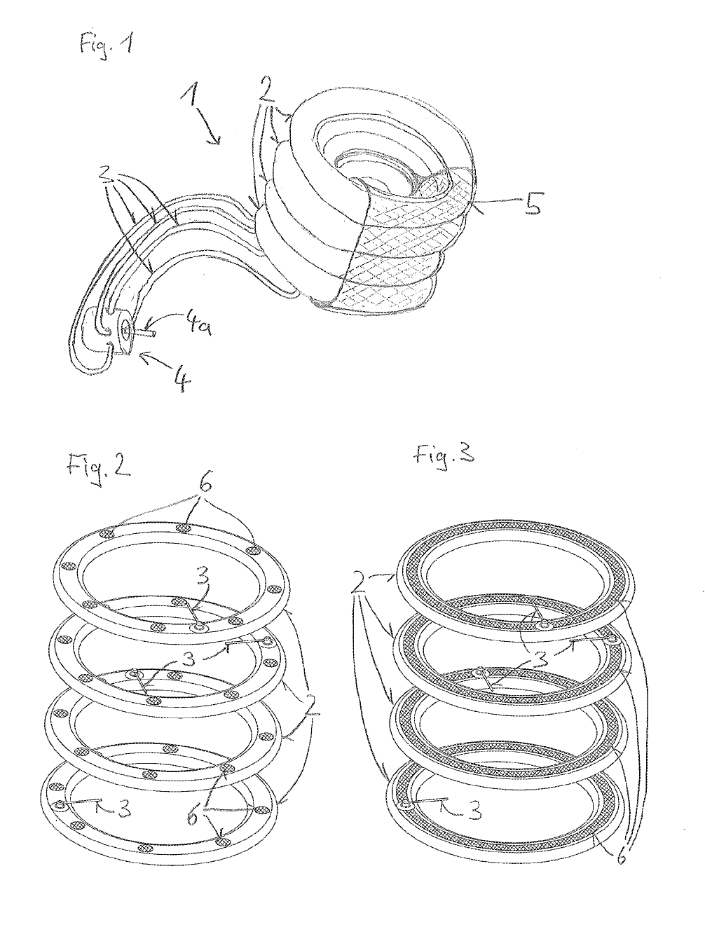

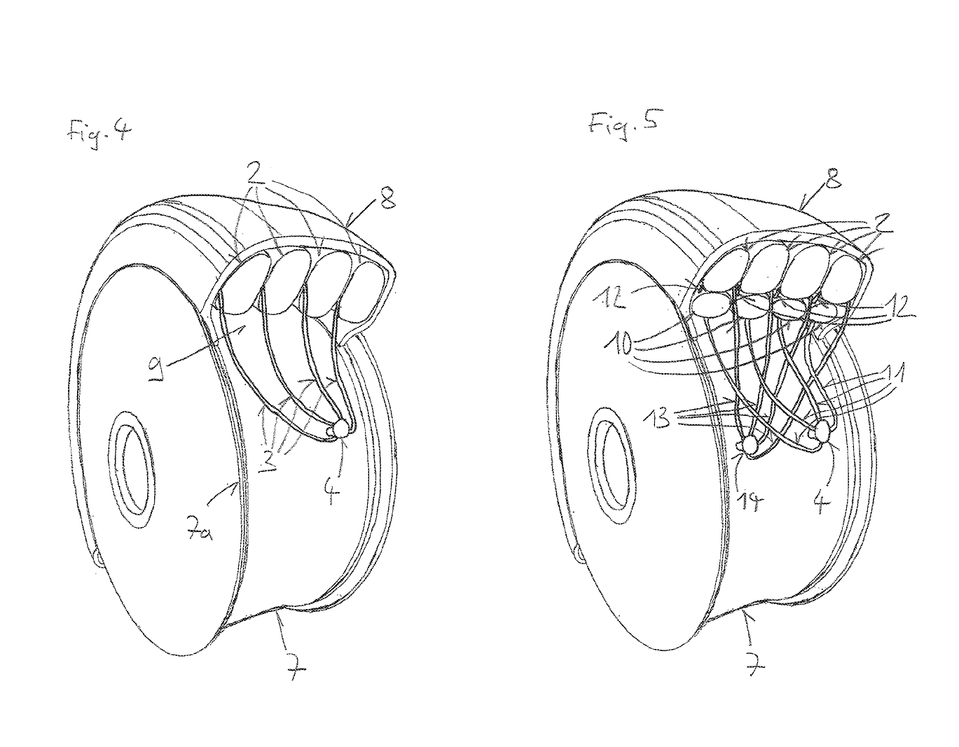

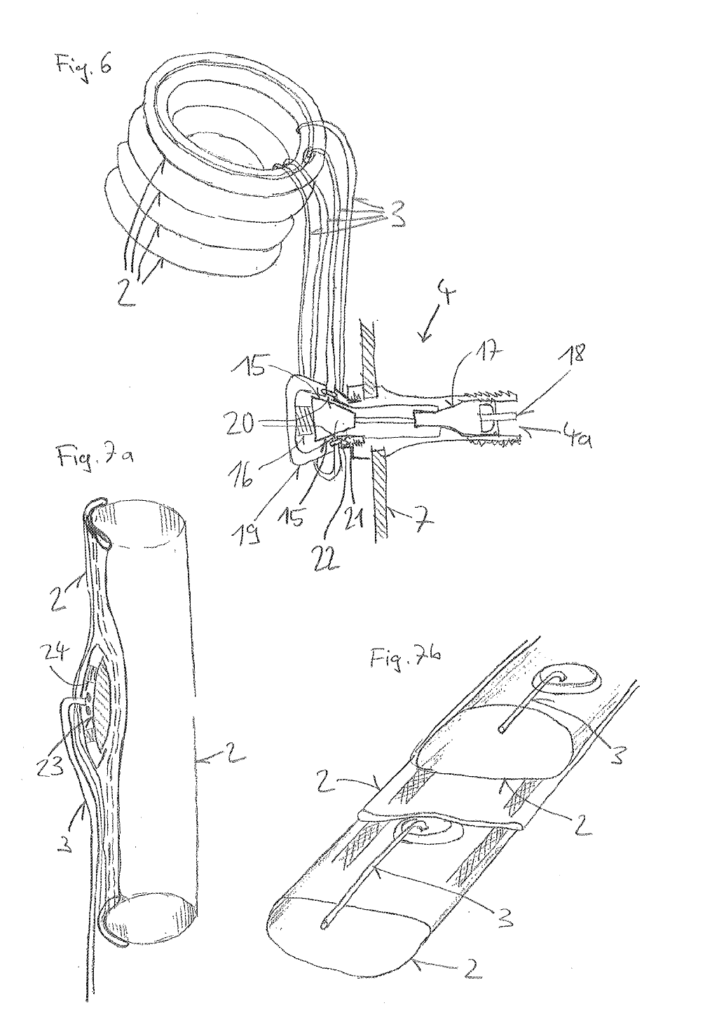

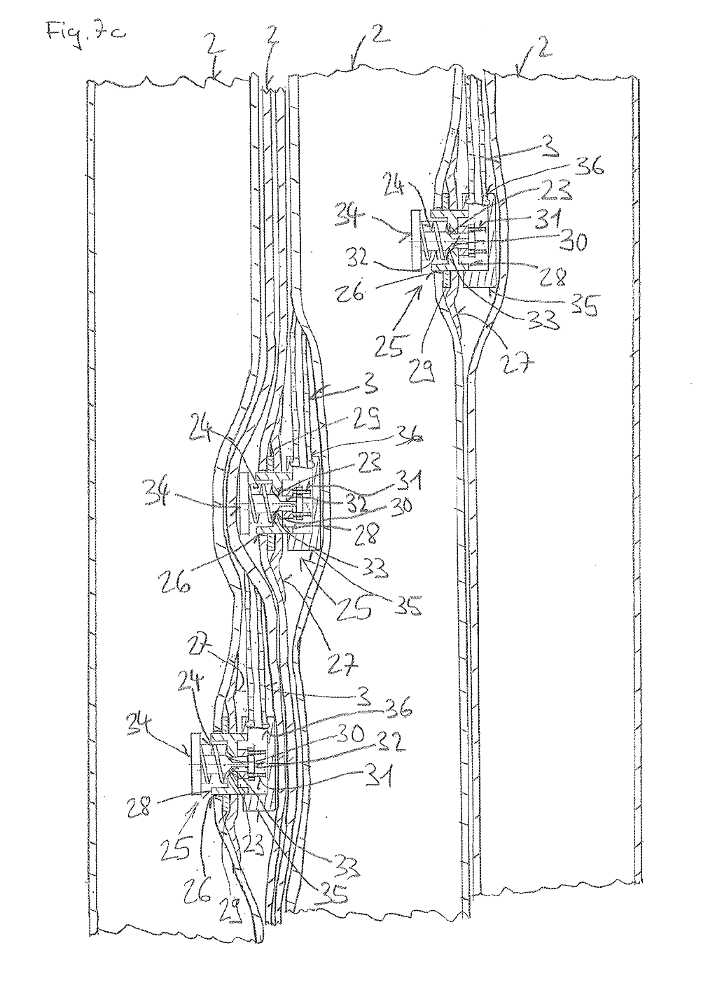

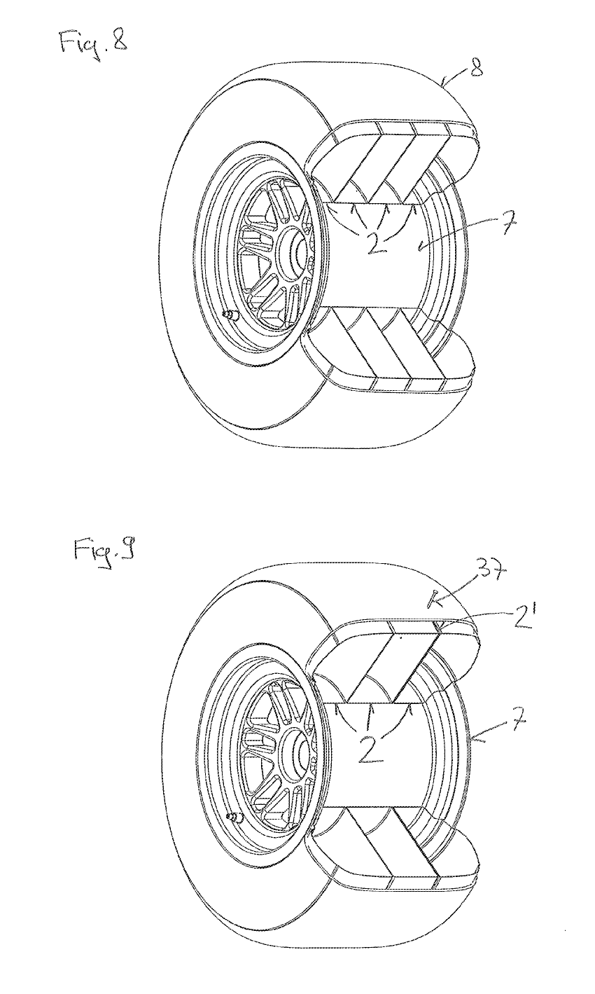

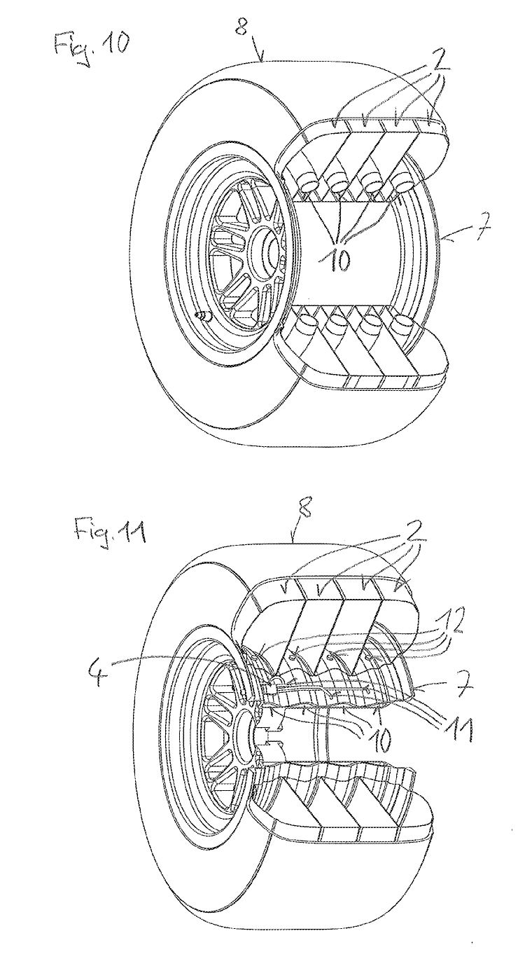

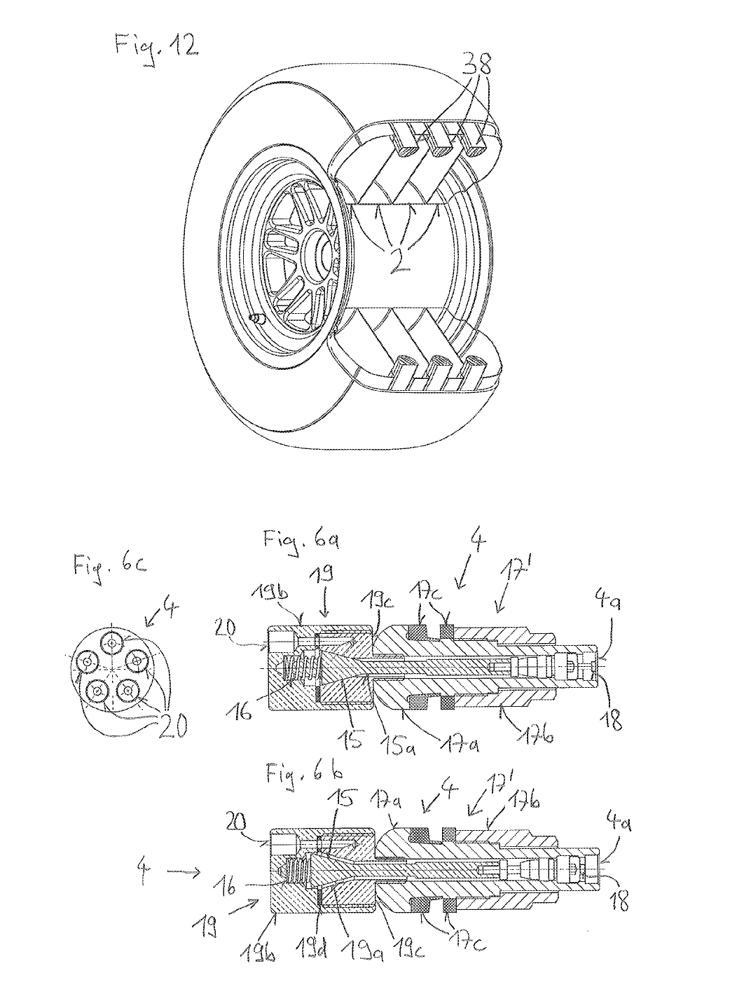

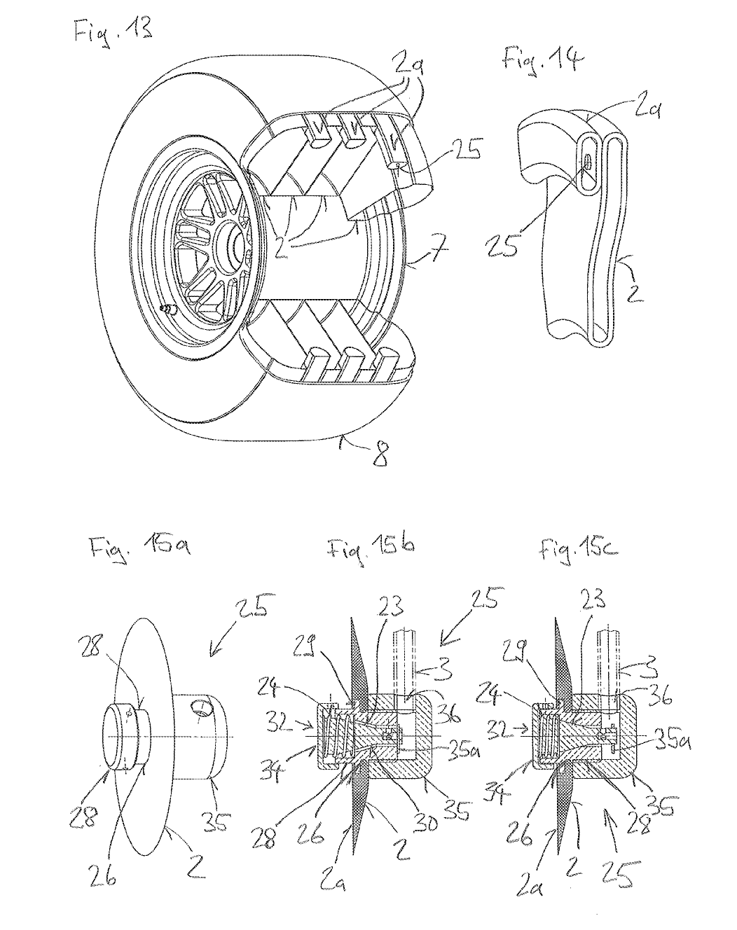

FIG. 4 shows a perspective view of a pressure safeguard device with a rim, a cut-open tire and four cut-open tubes, each of said tubes being connected via a supply line to a common supply connection on the rim,

FIG. 5 shows a perspective view of a pressure safeguard device with a rim, a cut-open tire, four cut-open tubes, and four cut-open pressure accumulators,

FIG. 6 shows a perspective view of a pressure safeguard device with four tubes, each of said tubes having a supply line for compressed gas and a common supply connection which comprises a supply opening and, for each supply line, a closure region,

FIGS. 6a and 6b show longitudinal sections through a supply connection in the closed and open valve position, respectively,

FIG. 6c shows a front view of the supply connection according to FIGS. 6a and 6b,

FIGS. 7a and 7b show perspective views of a detail of a pressure safeguard device, the details showing portions of two tubes and a differential pressure closing device for one or for both,

FIG. 7c shows a section through a detail of a pressure safeguard device, the detail showing portions of four tubes and a differential pressure closing device for three tubes,

FIG. 8 shows a perspective view of a pressure safeguard device with a rim, a cut-open tire and four cut-open filled tubes,

FIG. 9 shows a perspective view of a pressure safeguard device with a rim, a cut-open tire and four cut-open tubes, of which one is defective and the others are filled,

FIG. 10 shows a perspective view of a pressure safeguard device with a rim, a cut-open tire, four cut-open filled tubes and four cut-open pressure accumulators,

FIG. 11 shows a perspective view of a pressure safeguard device with a rim, a cut-open tire, four cut-open filled tubes and four cut-open pressure accumulators which are formed in the rim,

FIG. 12 shows a perspective view of a pressure safeguard device with a rim, a cut-open tire, four cut-open filled tubes, and three annular damping elements arranged between the tubes,

FIG. 13 shows a perspective view of a pressure safeguard device with a rim, a cut-open tire, four cut-open filled tubes, and three intermediate tubes arranged between the tubes,

FIG. 14 shows a detail of an arrangement comprising a tube and an intermediate tube arranged thereon,

FIG. 15a shows a perspective view of a differential pressure closing device, and

FIGS. 15b and 15c show sections through a differential pressure closing device in the open and closed state, respectively.

FIG. 1 shows a pressure safeguard device with four circularly closed tubes 2 which are arranged next to one another in such a way as to run around a common axis. Each tube 2 is connected via a supply line 3 to a common supply connection 4. In the inflated state, the tubes 2 are releasably connected by means of at least one connection device so as to form a stack, wherein the tubes 2 in the direction of the common axis directly adjoin one another along their circumference by way of side regions. The supply lines 3 are releasably attached to the common supply connection 4. The common supply connection 4 comprises a supply opening 4a, via which the tubes can be filled and emptied. In the illustrated embodiment, the connection device is formed of a flat material 5 which is arranged in a sleeve-like manner around the tubes at least in one circumferential region of the tubes. A contact or overlap region (not shown) comprises a connection arrangement, preferably comprising a releasable hook-and-loop connection, form-fitting connection or adhesive connection.

FIGS. 2 and 3 show tubes 2 with connection means which have, on at least one side of the tubes, connection elements 6 which are arranged in the circumferential direction of the tubes at least at two locations distributed substantially evenly around the circumference or which are arranged around the entire circumference. The connection elements 6 are formed of elements for hook-and-loop connections, latching connections or form-fitting connections or optionally of regions containing an adhesive which achieves a releasable connection. In the case of advantageous hook-and-loop connections, each tube will have first hook-and-loop elements on one side in the direction of the tire axis and second hook-and-loop elements on the other side, wherein the first and the second hook-and-loop elements can be releasably connected to one another. When connecting the tubes 2, the supply lines 3 are preferably led away toward the common axis so that they can be connected to a common supply connection 4 on a rim.

FIG. 4 shows a tube stack between a rim 7 and a tire 8 installed on the rim 7. During installation, first the supply lines 3 of the tubes 2 were connected to the common supply connection 4, which is arranged at a through-opening of the rim 7. The tubes 2 were then inflated via the common supply connection 4 to a first degree of filling, so that the tubes 2 are held in the tire 8 and provide a desired free space 9 on the side of the tire 8 facing toward the rim 7. In this state, the tire 8 can be installed on the rim 7 without any problem because the free space 9 is large enough for the radially outwardly projecting rim edge 7a.

To ensure the free space 9, the tire 8 and the circumferential lengths of the tubes 2 are adapted to one another in such a way that the tubes 2, after being arranged in the tire 8 and inflated to a first degree of filling, run with their smallest circumferential lines facing toward the tire axis around the tire axis at a radius which is a predefined amount larger than the inner radius of the tire edge lines with the smallest circumference of the tire 8.

FIG. 5 shows an embodiment in which each tube 2 is assigned its own pressure accumulator 10. The connections from the common supply connection 4 to the tubes 2 take place in a parallel manner via supply lines 11 into the associated pressure accumulators 10 and from the latter via top-up lines 12 into the corresponding tubes 2. Arranged between the pressure accumulators 10 and the tubes 2 are pressure-reducing valves (not shown) which ensure that the supply to each tube 2 takes place until a predefined pressure value is reached in the tire 8 and starts again when there is a drop below the predefined pressure value.

A check valve (not shown) is optionally arranged between each pressure-reducing valve and the tube 2 connected thereto, which check valve prevents gas from flowing back out of the tube 2 counter to the pressure accumulator 10. At least in the embodiments with check valves, in order to vent the tubes 2, a vent line 13 is connected to each tube 2 and at least one vent valve 14 is connected to the vent lines 13.

The pressure accumulators 10 comprise shaping means which restrict the expansion of the pressure accumulators when filling with the compressed gas or when building up an overpressure that is substantially above the predefined tire pressure. The overpressure required depends on the volume of the pressure accumulator, on the desired tire pressure, and on the top-up volume to be achieved in the associated tube, wherein the top-up volume to be achieved can be determined from the total number of tubes, the maximum number of defective tubes to be compensated, and the volume to be filled by the tubes in the tire.

FIG. 6 shows a schematic view of a common supply connection 4 which is arranged on the rim 7 and which comprises a supply opening 4a and, for each supply line 3, a closure region 15. The closure regions 15 are pretensioned by a pretensioning device 16, in particular a spring, so that all connections from the supply opening 4a into the supply lines 3 are closed individually. This ensures that, in the event of one leaking tube 2, the other tubes 2 cannot discharge compressed gas through the defective tube 2 to the surrounding environment via their supply lines 3.

In the illustrated embodiment, the supply opening 4a of the common supply connection 4 is provided with a check valve 17 which can be opened by pushing in a central pin 18. Moving this pin 18 also moves the closure regions 15 away from the connections to the supply lines 3 so that compressed gas can be discharged from the tubes 2 or, in the event of a higher pressure on the side of the supply opening, compressed gas can be filled into the tubes 2. It goes without saying that optionally only the pretensioned closure regions 15 are provided, without the additional check valve 17.

In the illustrated embodiment, the spacings between the closure regions 15 increase or decrease along the longitudinal axis of the supply connection 4. The lines of intersection of the closure regions 15 with normal planes to the longitudinal axis may be rectilinear or curved. The closure regions 15 are formed by partial surfaces of a displaceable valve body which is arranged in a correspondingly formed housing 19 with openings 20 to the supply lines 3.

The openings 20 and the supply lines 3 connected thereto can be tightly connected via releasable connections. In the illustrated embodiment, annular grooves 21 are formed at the openings 20 and the end regions of the supply lines 3 comprise corresponding annular beads 22 for engaging in the annular grooves 21. Because the internal cross-sectional area of the supply lines 3 can be selected to be small, the forces to be absorbed by the engagement-type connections are small.

The wall thickness and dimensional stability of the supply lines 3 is great enough that the latter remain open even when they are loaded from outside with customary tire pressures. This load capacity is necessary for emptying the tubes 2 because the supply lines 3 run inside the tire 8 from the tubes 2 to the common supply connection 4 and thus are loaded on their outer side with the tire pressure.

FIGS. 6a, 6b and 6c show a further embodiment of the common supply connection 4, which comprises a supply opening 4a and openings 20 to the supply lines 3 and connections therebetween which can be closed by closure regions 15. In the situation shown in FIG. 6a, the closure regions 15 formed on a central conical portion of a valve part 15a are pressed by the spring 16 against the receiving area 19a of the housing 19 which is adapted thereto, so that all the connections from the supply opening 4a to the openings 20 are closed. Supply lines 3 can be tightly connected to the openings 20 via releasable connections.

In the situation shown in FIG. 6b, the supply opening 4a of the common supply connection 4 is connected to all the openings 20 on account of the pushed-in central pin 18, the central conical portion of the valve part 15a displaced thereby and the closure regions 15 moved into the open position. Compressed gas can be introduced into tubes (not shown) or discharged therefrom via the supply connection 4 and supply lines (not shown).

The housing 19 comprises two housing parts 19b and 19c, which can be screwed to one another, and a sealing element 19d arranged therebetween, wherein the first housing part 19b has the openings 20 and also accommodates the spring 16, and the second housing part 19c is connected via a thread to the inner connection opening of a valve portion 17′ which can be fixed to a through-opening of the rim 7. The valve portion 17′ comprises a main part 17a and a sleeve 17b which can be securely screwed thereto. Elastic connection rings 17c of the main part 17a and of the sleeve 17b enable secure clamping of the valve portion 17′ at the through-opening of the rim 7.

In the illustrated embodiment, the closure regions 15 are arranged on a conical region having a circular cross-section, wherein this region belongs to a valve part 15a which is displaceably mounted in the correspondingly formed housing 19 and is connected to the central pin 18.

The vent valve 14 shown in FIG. 5 is preferably constructed in the same way as the common supply connection 4. On the vent valve 14, the vent lines 13 occur in place of the supply lines 3.

Embodiments and modes of operation of differential pressure closing devices will be explained with reference to FIGS. 7a, 7b and 7c. In the solutions shown, a closing element 23 for closing the connection is arranged at each connection of a tube 2 to the supply line 3 thereof. The closing element 23 is held open by an opening device, in particular a spring 24, with a predefined opening force. In the case of at least two tubes 2 which are arranged in a tire 8 and are filled with compressed gas, after a leak has occurred in one tube 2, the leaking tube is flattened by the remaining intact pressurized tubes 2. The closing element 23 is thereby moved into a closed position counter to the opening force. This prevents the situation whereby, when topping up compressed gas through the common supply connection 4, an undesirably large amount of the supplied compressed gas can escape through the tube 2 with the leak. The majority of the supplied compressed gas enters intact tubes.

FIG. 7c shows a closed differential pressure closing device on the defective tube and an open differential pressure closing device on two intact tubes. The differential pressure closing devices shown are configured as tube valves 25 and are attached to tube openings 26 by attachment patches 27. The tube valves 25 comprise a valve housing 28, from which an attachment ring 29 projects radially outward. The attachment ring 29 bears externally against the tube 2 at the tube opening 26 and is held tightly on the tube 2 by the attachment patch 27 connected to the tube 2. The valve housing 28 has a closable aperture 30 and a guide arrangement 31 for a movable closing part 32 comprising the closing element 23.

In the case of an intact tube 2, the closing part 32 is pressed by a spring 24 toward the open position and against a stop of the guide arrangement 31 so that the aperture 30 is open and compressed gas that is supplied through the supply line 3 can flow into the tube 2.

The movable closing part 32 comprises an actuating surface 34 which projects toward the interior of the tube 2. In a compressed tube 2, the actuating surface 34 and thus the movable closing part 32 is moved into the closed position counter to the spring force of the spring 24 so that the aperture 30 is closed and compressed gas that is supplied through the supply line 3 cannot flow into a defective tube 2.

The tube valve 25 comprises an end part 35 which is fixed to the valve housing 28 and which has a connection opening 36 for the supply line 3. The tube valve 25 can be formed in a compact and edge-free manner so that there is no risk of damage to the tubes even in the event of heavy loads caused by the pressure and the rolling motion of the tire.

FIG. 8 shows a rim 7, a cut-open tire 8 and four tubes 2 inflated between the rim 7 and the tire 8 in a cut-open view.

In FIG. 9, one of the four tubes 2 is damaged by a foreign object, for example a nail 37, so that the air escapes from the damaged tube 2′. Because an overpressure is still applied to the other tubes 2, the latter expand until the defective tube 2′ is flat and the other tubes, each with a similar volume, fill the space between the rim 7 and the tire 8.

When the tubes 12 are completely filled in the embodiment shown in FIG. 5 with pressure accumulators 10, the pressure accumulators 10 are optionally compressed somewhat against the rim 7 and the space between the rim 7 and the tire 8 is substantially filled by the tubes 2 and the pressure accumulators 10. However, because the pressure accumulators 10 are preferably less compressible, in FIG. 10 the tubes 2 are connected to the pressure accumulators 10 in particular in such a way that the tubes 2 on both sides of the associated pressure accumulator 10 expand toward the rim 7 so that the pressure accumulators 10 are surrounded by tube regions.

In the embodiment according to FIG. 11, the pressure accumulators 10 are formed in the rim 7, for example by two corrugated sheets being arranged in the manner of a mirror image and being tightly connected to one another at corrugation troughs. Annular chambers for the pressure accumulators 10 are formed between the annular connecting lines. From a common supply connection 4, supply lines 11 lead into the associated pressure accumulators 10, and top-up lines 12 lead from the latter into the corresponding tubes 2. Arranged between the pressure accumulators 10 and the tubes 2 are pressure-reducing valves (not shown) which ensure that the supply to each tube 2 takes place until a predefined pressure value is reached in the tire 8 and starts again when there is a drop below the predefined pressure value.

A check valve (not shown) is optionally arranged between each pressure-reducing valve and the tube 2 connected thereto, which check valve prevents gas from flowing back out of the tube 2 toward the pressure accumulator 10. At least in the embodiments with check valves, in order to vent the tubes 2, a vent line is connected to each tube 2 and at least one vent valve is connected to the vent lines.

FIG. 12 shows an embodiment in which annular damping elements 38 are arranged between the tube walls bearing against one another, preferably close to the inner surface of the tire 8. With such damping elements 38, both tube walls deviate somewhat from the radial orientation. In compression phases, the radially oriented portions of the tubes 2 press against the damping element, which is able to absorb the compression. To this end, the damping element is elastic, possibly made of sponge rubber or of a sufficiently elastic or damping plastic. The forces absorbed by the damping elements reduce the load on the tube walls.

In special embodiments, annular damping elements 38 between adjacent tubes 2 also perform a connection function in addition to the damping function. To this end, they comprise at least regions containing hook-and-loop elements, form-fitting connection elements or releasable adhesive.

FIGS. 13 and 14 show an embodiment with intermediate tubes 2a in regions where tube walls of the tubes 2 bear against one another. The intermediate tubes 2a directly adjoin the inner surface of the tire 8 and have, in the pressurized state of the tire 8, smaller cross-sectional areas than the other tubes 2 in planes through the tire axis. In one preferred embodiment, each intermediate tube 2a is fastened to at least one tube 2. In particular, it is fastened to both adjacent tubes 2 so that, after inflating the tubes 2 and the intermediate tubes 2a, the positions of the tubes 2 and intermediate tubes 2a shown in FIG. 13 are ensured.

Each intermediate tube 2a comprises a supply line and is connected to a common supply connection. In the illustrated embodiment, the connection of the intermediate tube 2a to the common supply connection runs via an adjacent tube 2 and from the adjacent tube, via the supply line thereof, to the common supply connection. A supply line could be used to connect the intermediate tube 2a to the tube 2. In the embodiment according to FIG. 13, the connection is achieved directly via a differential pressure closing device, preferably via a tube valve 25, which is inserted in the tube walls bearing against one another. This makes it possible to close the connection between the intermediate tube 2a and the tube 2 connected thereto in the event of a defective intermediate tube 2a by using the pressure of at least one intact tube.

FIGS. 15a, 15b and 15c show a differential pressure closing device in the form of a tube valve 25 which is inserted tightly into a tube opening 26. The tube valve 25 comprises a valve housing 28, from which an attachment ring 29 projects radially outward. The attachment ring 29 is tightly connected to the tube 2 and to the intermediate tube 2a. The valve housing 28 comprises a closable aperture 30 and a closing part 32 which is movable in the valve housing 28 and which has the closing element 23. In the case of an intact tube 2 or an intact intermediate tube 2a, the closing part 32 is pressed into the open position against a stop 35a by a spring 24 so that the aperture 30 is open and compressed gas that is supplied through the supply line 3 or from a tube 2 can flow into the tube 2 or into the intermediate tube 2a.

The movable closing part 32 comprises an actuating surface 34 which projects toward the interior of the tube 2 or of the intermediate tube 2a. In a compressed tube 2 or intermediate tube 2a, the actuating surface 34 and thus the movable closing part 32 is moved into the closed position counter to the spring force of the spring 24 so that the aperture 30 is closed by the closing element 23 and compressed gas that is supplied through the supply line 3 or from the tube 2 cannot flow into a defective tube 2 or intermediate tube 2a.

The tube valve 25 comprises an end part 35 which is fixed to the valve housing 28 and which has a connection opening 36 for the supply line 3 or to the tube 2. The tube valve 25 is formed in a compact and edge-free manner so that there is no risk of damage to the tubes even in the event of heavy loads caused by the pressure and the rolling motion of the tire.

In the embodiment shown in FIG. 14, the connection from the intermediate tube 2a to the tube 2 comprises substantially only a tube valve 25, wherein the tube 2 and the intermediate tube 2a are connected to one another at their coincident tube opening 26 and connect tightly to the tube valve 25. To connect the intermediate tube to at least one tube 2, use can be made of a connection means which is arranged on at least one tube 2, 2a and which comprises connection elements 6 which are arranged on at least one side of the at least one tube 2, 2a and which are arranged in the circumferential direction of the at least one tube 2, 2a at least at two locations distributed substantially evenly around the circumference, wherein said connection elements 6 are preferably formed of elements for hook-and-loop connections or optionally of regions containing an adhesive which achieves a connection.

A differential pressure closing device according to FIGS. 15a, 15b and 15c can also advantageously be used in each connection shown in FIGS. 7a, 7b and 7c from a supply line 3 to the tube 2 connected thereto.

1. A pressure safeguard device for wheels filled with compressed gas, in which at least two tubes which are closed in a circular fashion are arranged next to one another in a tire in such a way as to run around the tire axis and the tire can be installed on a rim, the pressure safeguard device comprising:
at least two, tubes (2),
a common supply connection;
a supply line from each tube to the common supply connection; and
wherein, on each supply line, a connectable and releasable connection is formed between the tube and the common supply connection.

2. The pressure safeguard device according to claim 1, wherein the tubes are releasably connected, by means of via a connection device which is separate from the tire, so as to form a stack of tubes which directly adjoin one another around their circumference by way of side regions.

3. The pressure safeguard device according to claim 1, wherein the connection device comprises at least one connection means which is arranged on at least one tube or which at least partially surrounds the tubes.

4. The pressure safeguard device according to claim 1, wherein the pressure safeguard device comprises a tire and the circumferential lengths of the tubes are adapted to the tire in such a way that, after being arranged in the tire and inflated to a first degree of filling, they run with their smallest circumferential lines facing toward the tire axis around the tire axis at a radius which is a predefined amount larger than the inner radius of the tire edge lines with the smallest circumference of the tire, wherein the tire edge lines bear against a rim in the installed state.

5. The pressure safeguard device according to claim 1, wherein the pressure safeguard device comprises a tire and a rim and the tubes in the tire and the tire with the tubes is arranged on the rim, wherein the supply lines are connected to the common supply connection, the common supply connection is arranged at a through-opening of the rim and comprises a supply opening and, for each supply line, a closure region.

6. The pressure safeguard device according to claim 5, wherein the pressure safeguard device comprises for each tube a differential pressure closing device which makes it possible to close the connection through the common supply connection to a defective tube, wherein each tube is assigned a closing element which, in the event of a defective tube, closes the connection from the supply opening into the defective tube as a result of an overpressure in at least one intact tube.

7. The pressure safeguard device according to claim 6, wherein the closing elements of the differential pressure closing device are arranged at the connections of the tubes to their supply lines, wherein each closing element is kept open by an opening device with a predefined opening force, in the case of at least two tubes which are arranged in a tire and are originally filled with compressed gas, after a leak has occurred in one tube the at least one remaining intact tube filled with compressed gas flattens the tube with the leak and thereby moves the closing element thereof into a closed position counter to the opening force so that, when compressed gas is topped up through the common supply connection, the supplied compressed gas cannot escape through the tube with the leak but rather fills the at least one other tube.

8. The pressure safeguard device according to claims 1, wherein the connection device comprises at least one connection means which is arranged on at least one tube and comprises connection elements which are arranged on at least one side of the at least one tube and which are arranged in the circumferential direction of the at least one tube at least at two locations distributed substantially evenly around the circumference, wherein the connection elements are preferably formed of elements for hook-and-loop connections or optionally of regions containing an adhesive which achieves a releasable connection.

9. The pressure safeguard device according to claim 8 wherein each tube comprises first hook-and-loop elements on one side in the direction of the tire axis and second hook-and-loop elements on the other side, wherein the first and the second hook-and-loop elements can be releasably connected to one another.

10. The pressure safeguard device according to claim 1, wherein each tube is assigned its own pressure accumulator and the connections from the common supply connection to the tubes take place in a parallel manner via supply lines, the associated pressure accumulators and top-up lines connected thereto, wherein pressure-reducing valves are arranged between the pressure accumulators and the tubes, which pressure-reducing valves ensure that the supply to each tube takes place until a predefined pressure value is reached in the tire and starts again when there is a drop below the predefined pressure value in the tire, wherein a check valve is preferably arranged between each pressure-reducing valve and the tube connected thereto, which check valve prevents gas from flowing back out of the tube toward the pressure accumulator, and in particular at least one vent valve is connected to the tubes for venting the tubes.

11. The pressure safeguard device according to claim 10, wherein at least four pressure accumulators are used, wherein the pressure accumulators, preferably as elements running in a circular fashion around the tire axis, then run radially at the associated tubes toward the tire axis and are connected to the tubes or to one another preferably via a releasable connection.

12. The pressure safeguard device according to claim 11, wherein the circumferential lengths of the pressure accumulators are adapted to an associated tire in such a way that, once the tubes and the pressure accumulators have been arranged in the tire and the tubes have been inflated to a first degree of filling, the smallest circumferential lines of the pressure accumulators facing toward the tire axis run around the tire axis at a radius which is a predefined amount larger than the inner radius of the tire edge lines with the smallest circumference of the tire, wherein the tire edge lines bear against the rim in the installed state.

13. A method for ensuring a predefined pressure value in a pressure safeguard device according to claim 5, wherein, after a reduction in pressure due to a defective tube, a compressed gas source, is connected to the common supply connection and substantially the gas volume that has escaped from the defective tube is filled into the leaktight tubes until a predefined pressure value is reached in the tire.

14. The method according to claim 13, wherein the gas used for filling from the pressure cylinder is nitrogen.

15. The pressure safeguard device according to claim 1, wherein the at least two tubes are at least four tubes.

16. The pressure safeguard device according to claim 1, wherein the at least two tubes are at least five tubes.

17. The pressure safeguard device according to claim 11, wherein the at least four pressure accumulators are at least five pressure accumulators.

18. The method according to claim 13, wherein the compressed gas source is a compressed gas cylinder.
